(19) United States
(12) Patent Application Publication
(10) Pub. No.: US 2026/0254157 A1
(43) Pub. Date: Aug. 27, 2026

(54) CONNECTOR

(71) Applicant: SUMITOMO WIRING SYSTEMS, LTD., Mie (JP)

(72) Inventor: Ryuya USUI, Mie (JP)

(21) Appl. No.: 19/547,197

(22) Filed: Feb. 23, 2026

(30) Foreign Application Priority Data
Feb. 25, 2025 (JP) 2025-027975

(51) Int. Cl. H01R 13/58; H01R 13/506

(52) U.S. Cl. CPC H01R 13/5825; H01R 13/506; H01R 2201/26

(57) ABSTRACT

A connector of the present disclosure includes a terminal, a housing including a wire pull-out portion and configured to accommodate the terminal, and a wire to be connected to the terminal and pulled out in a first direction from the wire pull-out portion of the housing. The housing includes a housing body and a cover member to be assembled with the housing body. The wire pull-out portion includes a receiving portion provided in the housing body and configured to receive the wire from one side in a second direction orthogonal to the first direction, and a pressing portion provided in the cover member and configured to press the wire from another side in the second direction.

### CROSS-REFERENCE TO RELATED APPLICATIONS

This application is based on and claims priority from Japanese Patent Application No. 2025-027975, filed on February 25, 2025, with the Japan Patent Office, the disclosure of which is incorporated herein in its entirety by reference.

### TECHNICAL FIELD

The present invention relates to a connector.

### BACKGROUND

Conventionally, a connector described in Japanese Patent Laid-open Publication No. 2016-021397 is known. This connector is a connector used to control an airbag inflator or the like, i.e. a so-called squib connector, and installed in a vehicle. The connector of this type is provided with a terminal, a housing for holding the terminal, a locking member accommodated inside the housing and a spring for biasing the locking member. This connector is structured such that an electrical cable is pressed by a body of the connector housing and a cover of the connector housing.

### SUMMARY

In the above configuration, the electrical cable is mounted inside the body of the connector housing and fixed at a predetermined position by the cover of the connector housing, but a structure for restricting the position and the posture of the cable is not provided in the connector housing. Thus, for example, in the case of an operation to assemble the body and the cover of the connector housing, the cable may deviate from a proper position and is thought to be sandwiched between the body and the cover of the connector housing.

The present disclosure is directed to a connector with a terminal, a housing including a wire pull-out portion, the housing accommodating the terminal, and a wire to be connected to the terminal, the wire being pulled out in a first direction from the wire pull-out portion of the housing, the housing including a housing body and a cover member to be assembled with the housing body, the wire pull-out portion including a receiving portion provided in the housing body, the receiving portion receiving the wire from one side in a second direction orthogonal to the first direction, and a pressing portion provided in the cover member, the pressing portion pressing the wire from another side in the second direction, and the receiving portion including an accommodation groove having an opening open on the other side in the second direction, the wire being accommodated at a proper position in the accommodation groove, and a pair of tapered portions formed to be wider apart from the opening toward the other side in the second direction.

According to the present disclosure, it is possible to provide a connector capable of suppressing the jamming of a wire when the connector is assembled.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector of one embodiment.

FIG. 2 is an exploded perspective view showing the connector of the embodiment.

FIG. 3 is a plan view showing a part of the connector before a cover member of the embodiment is mounted.

FIG. 4 is a perspective view showing the cover member of the connector of the embodiment.

FIG. 5A is a front view showing a state before the cover member is assembled in an assembly process of wires and the cover member in a wire pull-out portion of the embodiment.

FIG. 5B is a front view showing a state where the wires are accommodated before the cover member is assembled in the assembly process of the wires and the cover member in the wire pull-out portion of the embodiment.

FIG. 5C is a front view showing a state where the cover member is assembled after the wires are accommodated in the assembly process of the wires and the cover member in the wire pull-out portion of the embodiment.

FIG. 6 is a perspective view in section along A-A of FIG. 5C.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a terminal, a housing including a wire pull-out portion, the housing accommodating the terminal, and a wire to be connected to the terminal, the wire being pulled out in a first direction from the wire pull-out portion of the housing, the housing including a housing body and a cover member to be assembled with the housing body, the wire pull-out portion including a receiving portion provided in the housing body, the receiving portion receiving the wire from one side in a second direction orthogonal to the first direction, and a pressing portion provided in the cover member, the pressing portion pressing the wire from another side in the second direction, and the receiving portion including an accommodation groove having an opening open on the other side in the second direction, the wire being accommodated at a proper position in the accommodation groove, and a pair of tapered portions formed to be wider apart from the opening toward the other side in the second direction.

According to this configuration, even if the wire is located at halfway positions of the tapered portions, for example, when the cover member is assembled with the housing body, the pressing portion can push the wire to the proper position and the jamming of the wire can be suppressed by the pressing portion of the cover member and the receiving portion of the housing body. Further, since the wire is reliably accommodated at the proper position, it can be suppressed that the wire swings and vibration is transmitted to the terminal.

[2] Preferably, in the connector of [1] described above, the wire is sandwiched in the second direction by the receiving portion and the pressing portion at the proper position.

According to this configuration, the wire pulled out in the first direction from the wire pull-out portion is accommodated and held at the proper position, and movements of the wire in the first and second directions can be suppressed.

[3] Preferably, in the connector of [1] or [2] described above, an inner wall of the accommodation groove in the receiving portion is formed with a projection for sandwiching the wire in a third direction orthogonal to the first and second directions at the proper position.

According to this configuration, a movement of the wire in the third direction can be suppressed by sandwiching the wire in the third direction by the projection in the accommodation groove.

Further, since the wire can be accommodated in the accommodation groove and held at the proper position when the cover member is removed from the housing body, the jamming of the wire can be more easily suppressed.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. Further, "orthogonal" and "parallel" in this specification mean not only strictly orthogonal and parallel, but also substantially orthogonal and parallel within a range in which functions and effects in this embodiment are achieved. A term "tubular" used in the description of this specification indicates not only a shape formed by a peripheral wall continuous over an entire periphery in a circumferential direction, but also a tubular shape formed by combining a plurality of components and a shape having a cut or the like in a circumferential part such as a C shape and a U shape. Note that "tubular" shapes include circular shapes, elliptical shapes and polygonal shapes with angular or rounded corners, but there is no limitation to these. "Facing each other" in this specification indicates that surfaces or members are at positions in front of each other, and means not only a case where the surfaces or members are at positions perfectly in front of each other, but also a case where the surfaces or members are partially in front of each other. "Facing each other" in this specification means not only a case where two members are away from each other, but also a case where the two members are in contact with each other. Further, terms such as "first", "second" and "third" in this specification are merely used to distinguish objects and do not rank the objects. Note that the present invention is not limited to these illustrations, but is represented by claims and intended to include all changes in the scope of claims and in the meaning and scope of equivalents.

### Embodiment

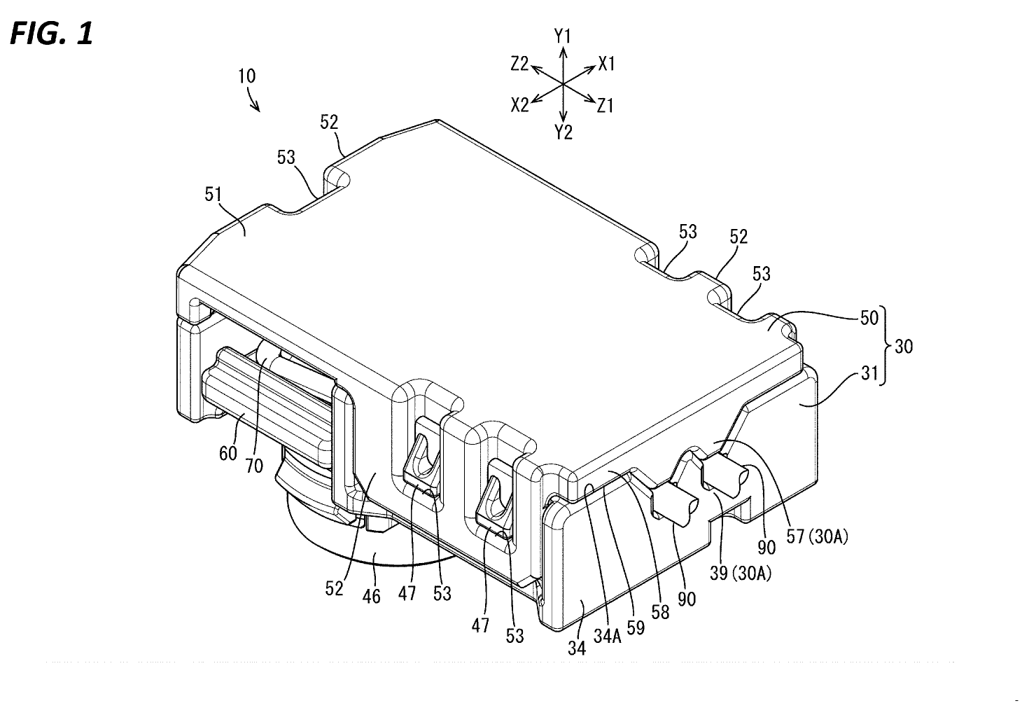

An embodiment of the present disclosure is described with reference to FIGS. 1 to 6. In the following description, an X-axis direction is a lateral direction, a Y-axis direction is a vertical direction and a Z-axis direction is a front-rear direction. In each figure, the X-axis direction, the Y-axis direction orthogonal to the X-axis direction and the Z-axis direction orthogonal to both the X-axis direction and the Y-axis direction are shown. A direction indicated by an arrow line X1, which is one direction along the X-axis direction of each figure, is a rightward direction, and a direction indicated by an arrow line X2, which is another direction along the X-axis direction and opposite to the rightward direction X1, is a leftward direction. A direction indicated by an arrow line Y1, which is one direction along the Y-axis direction of each figure, is an upward direction, and a direction indicated by an arrow line Y2, which is another direction along the Y-axis direction and opposite to the upward direction Y1, is a downward direction. A direction indicated by an arrow line Z1, which is one direction along the Z-axis direction of each figure, is a forward direction, and a direction indicated by an arrow line Z2, which is another direction along the Z-axis direction and opposite to the forward direction Z1, is a rearward direction. Here, the downward direction Y2 is a forward direction along a connection direction of a connector 10 to a mating connector (not shown). The forward direction Z1 is a forward direction along a wire pull-out direction, in which wires 90 are pulled out. In this embodiment, the front-rear direction is an example of a first direction, the vertical direction is an example of a second direction, and the lateral direction is an example of a third direction. Further, for a plurality of identical members, only some members may be denoted by a reference sign and the other members may not be denoted by the reference sign.

### Overall Configuration of Connector 10

As shown in FIG. 1, the connector 10 is configured to be connectable to the mating connector (not shown). The connector 10 is, for example, provided in an unillustrated vehicle such as an ordinary vehicle, a hybrid vehicle or an electric vehicle. Further, the connector 10 is a connector used to control a seat-belt pretensioner, an airbag inflator or the like, i.e. a so-called squib connector.

### Configuration of Connector 10

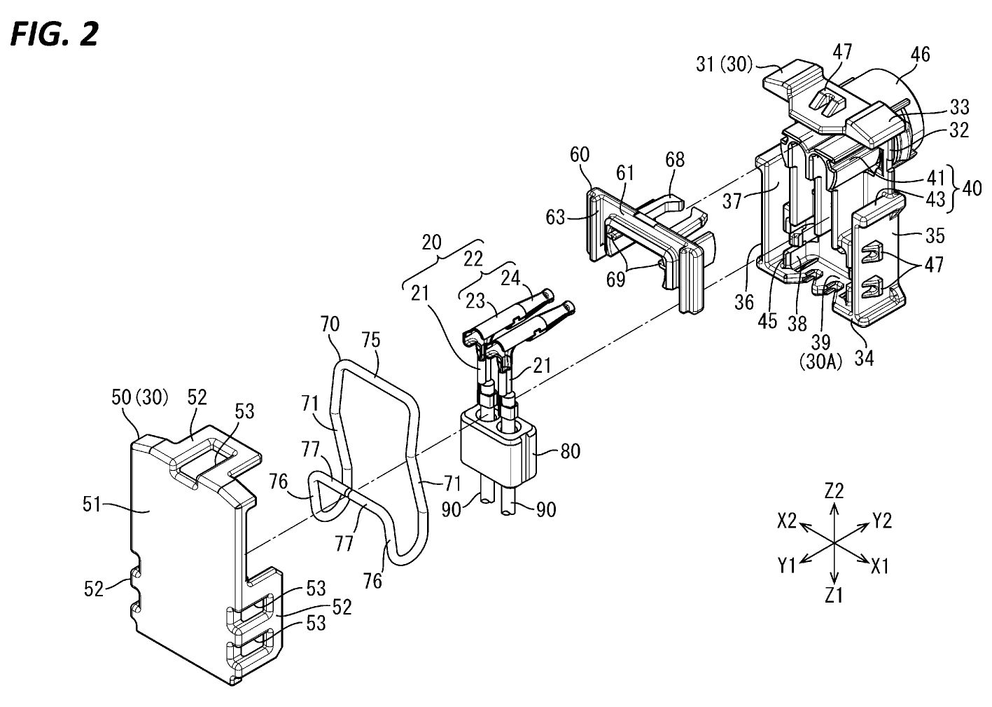

As shown in FIG. 2, the connector 10 (see FIG. 1) is provided with terminals 20, a housing 30, a slider 60, a spring 70, and a ferrite core 80. The connector 10 of this embodiment is provided with two terminals 20.

### Configuration of Terminal 20

As shown in FIG. 2, the two terminals 20 are provided side by side along the X-axis direction (lateral direction). Each terminal 20 includes a wire connecting portion 21 and a female terminal portion 22. The wire connecting portion 21 extends along the Z-axis direction (front-rear direction). The female terminal portion 22 extends along the Y-axis direction (vertical direction). Each terminal 20 is formed into an L shape as a whole when viewed from the X-axis direction. Each terminal 20 is made of metal.

As shown in FIG. 2, the wire connecting portion 21 is connected to the wire 90. Here, the wire 90 is a coated wire including an electrically conductive core wire and an insulation coating covering the outer periphery of the core wire. The wire connecting portion 21 is connected to an end part of the core wire of the wire 90. The wire connecting portion 21 is, for example, connected to the core wire of the wire 90 by crimping, ultrasonic welding or the like.

The female terminal portion 22 is connected to an end part in the rearward direction Z2 of the wire connecting portion 21. The female terminal portion 22 extends in a direction orthogonal to a length direction of the wire connecting portion 21. The female terminal portion 22 is formed into a tubular shape. The female terminal portion 22 includes a connecting portion 23 to be connected to the wire connecting portion 21 and a tongue piece 24.

The connecting portion 23 is in the form of a groove open in the rightward direction X1. The connecting portion 23 is open in the downward direction Y2 and open in the upward direction Y1. Further, the connecting portion 23 extends in the downward direction Y2 from the wire connecting portion 21 and extends in the upward direction Y1 from the wire connecting portion 21.

The tongue piece 24 is formed into a substantially tubular shape extending in the downward direction Y2 from an end part in the downward direction Y2 of the connecting portion 23 with a slit formed in the Y-axis direction. A mating terminal (not shown) is inserted into the tongue piece 24. An internal space of the tongue piece 24 communicates with that of the connecting portion 23.

### Configuration of Housing 30

As shown in FIG. 2, the housing 30 includes a housing body 31 and a cover member 50 formed to be attachable to the housing body 31. The housing body 31 is formed into a box shape open in the upward direction Y1. The cover member 50 is attached to the housing body 31 to close an opening of the housing body 31. The housing body 31 and the cover member 50 are separate components. Each of the housing body 31 and the cover member 50 is made of resin.

The housing 30 is formed into a tubular shape to surround the terminals 20, the slider 60 and the spring 70 by uniting the housing body 31 and the cover member 50. In other words, the terminals 20, the slider 60 and the spring 70 are accommodated in an internal space of the housing 30 formed by the housing body 31 and the cover member 50.

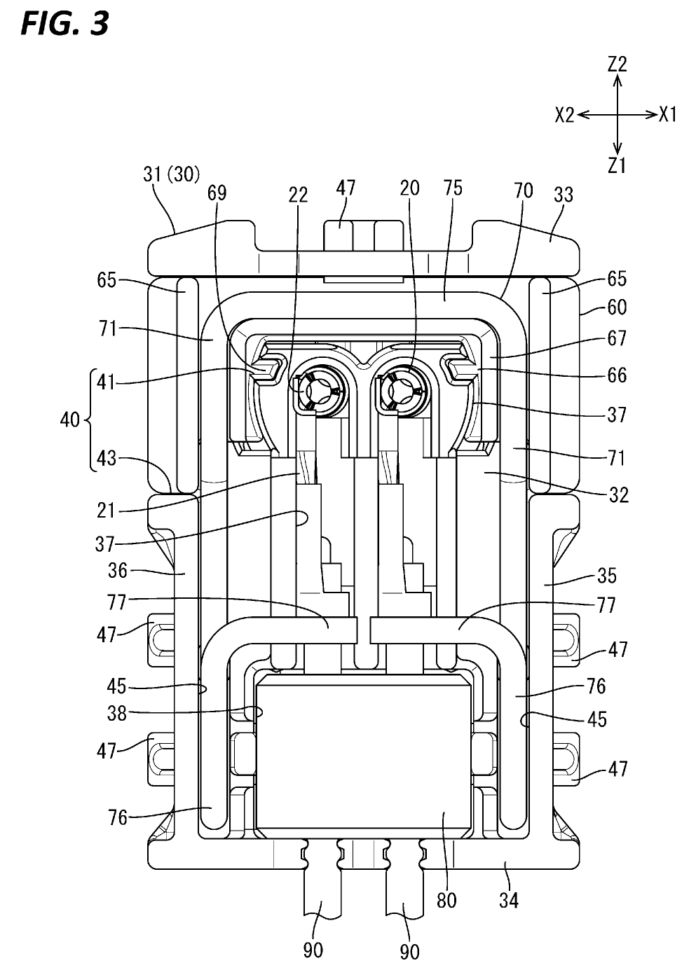

As shown in FIGS. 2 and 3, the housing body 31 includes a base portion 32 and peripheral walls 33, 34, 35 and 36 projecting in the upward direction Y1 from the base portion 32. The housing body 31 includes a terminal accommodating portion 37 for accommodating the terminals 20 and a ferrite accommodating portion 38 for accommodating the ferrite core 80. The housing body 31 includes a mounting portion 40 having the slider 60 mounted therein and spring accommodating portions 45 for accommodating the spring 70. As shown in FIG. 3, the housing body 31 includes two spring accommodating portions 45. Note that the cover member 50 is not shown in FIG. 3 to simplify the drawing.

As shown in FIG. 2, the base portion 32 is in the form of a flat plate. The peripheral wall 33 is provided on an end part in the rearward direction Z2 of the base portion 32. The peripheral wall 34 is provided on an end part in the forward direction Z1 of the base portion 32. The peripheral walls 33, 34 extend along the X-axis direction (lateral direction). The peripheral wall 35 is provided on an end part in the rightward direction X1 of the base portion 32. The peripheral wall 36 is provided on an end part in the leftward direction X2 of the base portion 32. The peripheral walls 35, 36 extend along the Z-axis direction (front-rear direction).

The slider 60 is mounted along the downward direction Y2 into the mounting portion 40. The mounting portion 40 holds the slider 60 movably along the Y-axis direction (front-rear direction) in the internal space of the housing 30. The mounting portion 40 includes guide grooves 41 provided in the outer peripheral surface of the terminal accommodating portion 37 and cut portions 43 provided in the peripheral walls 35, 36.

As shown in FIGS. 1 and 2, the housing body 31 includes a fitting tube portion 46 to be fit to a mating fitting tube portion of a mating housing (not shown). The fitting tube portion 46 is fit into the mating fitting tube portion (not shown). As shown in FIG. 2, the fitting tube portion 46 projects in the downward direction Y2 from the base portion 32.

As shown in FIG. 3, the housing body 31 includes engaged portions 47 provided on the peripheral walls 33, 35 and 36. The engaged portions 47 are engaging projections projecting outward from the outer surfaces of the peripheral walls 33, 35 and 36. The peripheral wall 33 is provided with one engaged portion 47. Each of the peripheral walls 35, 36 is provided with two engaged portions 47.

### Configuration of Cover Member 50

As shown in FIG. 1, the cover member 50 is attached to the housing body 31. The cover member 50 is formed to be attachable to and detachable from the housing body 31. The cover member 50 includes a cover body portion 51, engaging portions 52 projecting in the downward direction Y2 from the cover body portion 51 and a peripheral wall 58 projecting in the downward direction Y2 from the cover body portion 51. The cover member 50 of this embodiment includes three engaging portions 52 corresponding to the engaged portions 47 of the housing body 31.

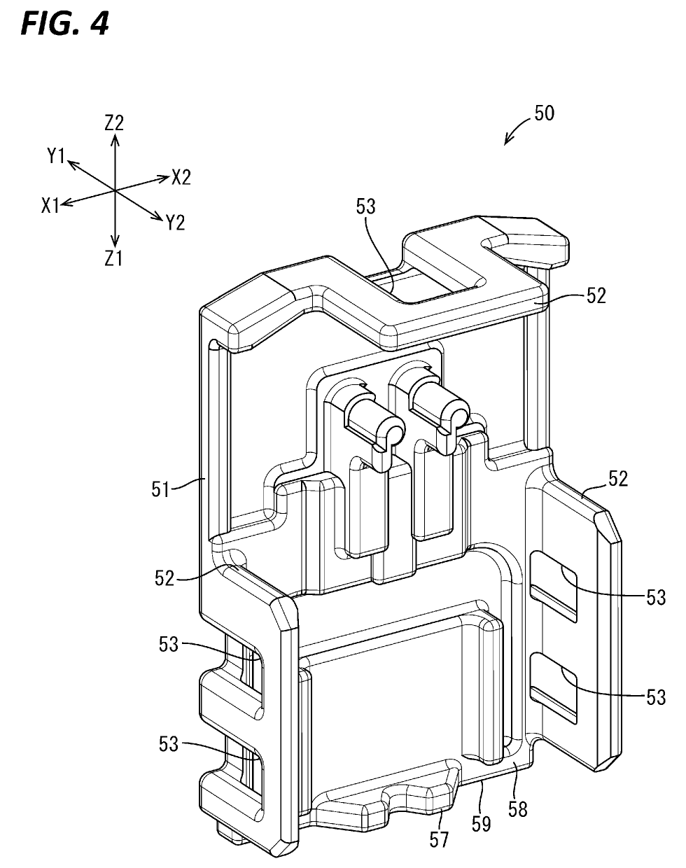

As shown in FIGS. 1 and 4, the cover body portion 51 is in the form of a flat plate. The cover body portion 51 is formed to close an opening in the upward direction Y1 of the housing body 31. Each engaging portion 52 projects from the cover body portion 51 toward the housing body 31. Each engaging portion 52 is a resilient piece formed to be resiliently deformable. Each engaging portion 52 is formed to project in the downward direction Y2 from the peripheral edge of the cover body portion 51. One engaging portion 52 is formed on each of long sides and one engaging portion 52 is formed on one short side, out of the peripheral edge of the cover body portion 51. Each engaging portion 52 includes an engaging hole 53 capable of accommodating the engaged portion 47. The engaged portion 47 and the engaging portion 52 are engaged with each other by the resilient deformation of the resilient piece of the engaging portion 52. The engaged portions 47 are fit into the engaging holes 53 and engaged with the engaging portions 52, whereby the housing body 31 and the cover member 50 are maintained in a united state.

### Configuration of Slider 60

As shown in FIGS. 2 and 3, the slider 60 includes a slider body portion 61, a spring accommodating portion 63, a connection assuring portion 68 and guide protrusions 69. The slider 60 is a single component integrally formed with the slider body portion 61, the spring accommodating portion 63, the connection assuring portion 68 and the guide protrusions 69. The slider 60 is made of resin.

As shown in FIG. 3, the slider 60 is accommodated inside the housing 30. The slider 60 is held by the housing body 31 movably to a first position and a second position along the Y-axis direction (vertical direction). The first position is a position where the slider body portion 61 is engaged with the base portion 32 of the housing body 31 in the Y-axis direction (vertical direction). The second position is a position where the slider 60 is pressed in the upward direction Y1 by the mating housing (not shown).

When the housing 30 and the mating housing (not shown) are connected, the slider 60 is pressed in the upward direction Y1 by the mating housing (not shown). In this way, the slider 60 parallelly moves from the first position to the second position along the Y-axis direction (vertical direction) while compressing the spring 70 in the Y-axis direction (vertical direction) against a biasing force of the spring 70. If the slider 60 is further pressed by the mating housing (not shown) while being arranged at the second position, the connection assuring portion 68 is resiliently deformed to widen an opening and a mating connection assuring portion (not shown) enters the connection assuring portion 68. In this way, a movement in the downward direction Y2 of the slider 60 is allowed. If the connector 10 and the mating connector (not shown) are properly connected, the slider 60 arranged at the second position is biased toward the first position by the spring 70 and the slider 60 parallelly moves from the second position to the first position along the Y-axis direction (vertical direction).

As shown in FIGS. 2 and 3, the spring accommodating portion 63 is formed to be able to accommodate a part of the spring 70. A plan view shape of the spring accommodating portion 63 viewed from the downward direction Y2 is a U shape. An internal space of the spring accommodating portion 63 is formed by a space surrounded by a bottom surface (not shown), wall portions 65, 66 and the peripheral wall 33 of the housing body 31. The wall portion 66 includes, for example, a guiding portion 67. The guiding portion 67 is formed into an inclined surface (not shown) inclined in the downward direction Y2 from the projecting tip surface of the wall portion 66 (i.e. an end surface in the upward direction Y1) toward the internal space of the spring accommodating portion 63 in a back view from the Y-axis direction. The guiding portion 67 has a function of guiding the spring 70 into the internal space of the spring accommodating portion 63.

### Configuration of Spring 70

As shown in FIG. 2, the spring 70 is formed of a wire material. The spring 70 is made of metal. The spring 70 includes a pair of arms 71 and a coupling portion 75 coupling the pair of arms 71. The spring 70 includes a pair of folded portions 76 respectively provided on end parts of the pair of arms 71 and a pair of extending portions 77 respectively provided on the tips of the pair of folded portions 76. The spring 70 is such a single component that the arms 71, the coupling portion 75, the folded portions 76 and the extending portions 77 are continuously and integrally formed.

The coupling portion 75 couples end parts in the rearward direction Z2 of the pair of arms 71. The coupling portion 75 extends along the X-axis direction (lateral direction). The coupling portion 75 is accommodated in the spring accommodating portion 63 of the slider 60. The coupling portion 75 is in line contact with the bottom surface of the spring accommodating portion 63 (see FIG. 3).

The pair of folded portions 76 are provided to face each other in the X-axis direction (lateral direction). Each folded portion 76 is formed to be folded from an end part in the forward direction Z1 of each arm 71 toward the end part in the rearward direction Z2 of each arm 71. Each folded portion 76 is formed to be folded in a direction separating from the base portion 32 of the housing body 31 (here, the upward direction Y1). Each folded portion 76 is folded into a U shape from the end part in the forward direction Z1 of each arm 71. Each folded portion 76 is provided to be able to contact the inner surface of the cover member 50.

Each extending portion 77 extends toward the other arm 71 from the tip (here, an end part in the rearward direction Z2) of each folded portion 76. Each extending portion 77 is provided to be able to contact the inner surface of the cover member 50.

### Configuration of Ferrite Core 80

The ferrite core 80 is mounted on the outer peripheries of the wires 90. The ferrite core 80 is formed to surround the outer peripheries of the wires 90. The wire 90 is passed through the ferrite core 80 in the Z-axis direction (front-rear direction). The ferrite core 80 is accommodated into the ferrite accommodating portion 38 of the housing body 31.

### Wire Pull-Out Portion 30A of Housing 30

As described above, the housing body 31 and the cover member 50 are maintained in the united state by the engagement of the engaged portions 47 and the engaging portions 52. In the housing 30, a wire pull-out portion 30A is provided in a front end part where engaging structures of the engaged portions 47 and the engaging portions 52 are not provided. The wires 90 are pulled out in the forward direction Z1 from the wire pull-out portion 30A. With the wires 90 pulled out, the peripheral wall 58 of the cover member 50 and the peripheral wall 34 of the housing body 31 are facing each other in the vertical direction. The wire pull-out portion 30A is configured to include a pair of later-described receiving portions 39 of the housing body 31 and a pair of later-described pressing portions 57 of the cover member 50.

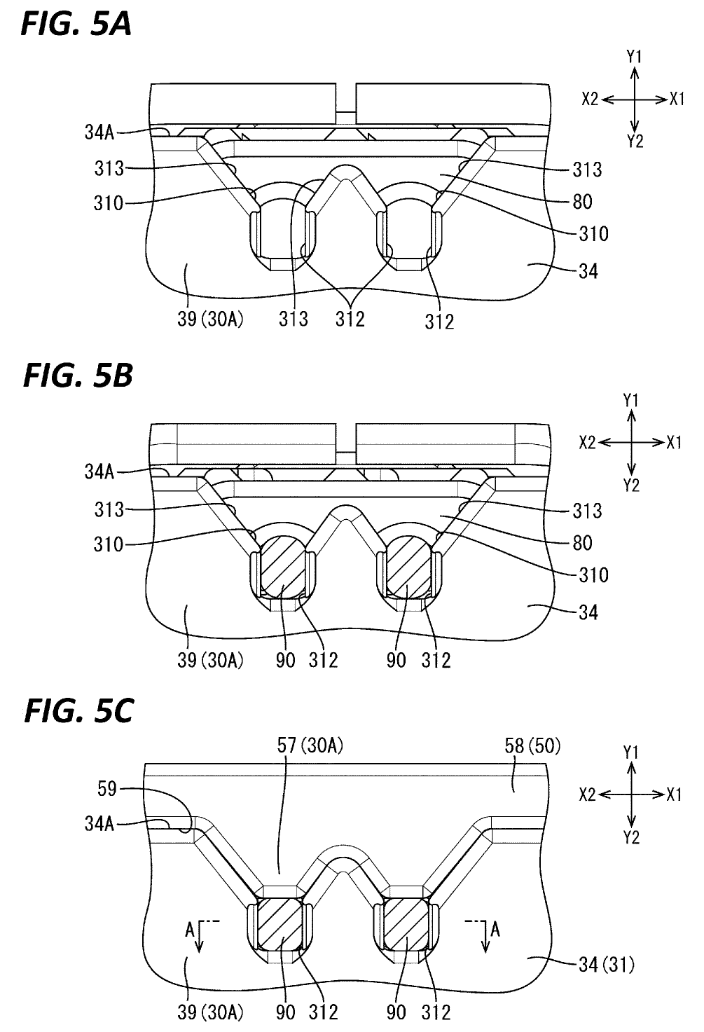

As shown in FIG. 1, the pair of pressing portions 57 of the cover member 50 are formed on the peripheral wall 58. As shown in FIGS. 4 and 5C, the peripheral wall 58 has a facing surface 59 facing the housing body 31 at the time of assembly. The pair of pressing portions 57 are formed in a lateral central part of the peripheral wall 58. In other words, the pressing portion 57 is a part projecting in the downward direction Y2, out of the peripheral wall 58. The pressing portion 57 is formed into a tapered shape having a dimension in the lateral direction reduced in the downward direction Y2. A lower end part of the pressing portion 57 is formed into a flat surface extending in the lateral direction. This flat surface constitutes a part of the facing surface 59. As shown in FIG. 5C, the pair of pressing portions 57 are fit into the pair of receiving portions 39 of the housing body 31 from above.

As shown in FIGS. 1 and 5A, the pair of receiving portions 39 of the housing body 31 are formed in the peripheral wall 34. The receiving portion 39 is a part for receiving the wire 90 from the downward direction Y2. The pair of receiving portions 39 are formed in a lateral central part of the peripheral wall 34. In other words, the receiving portion 39 is a part recessed in the downward direction Y2, out of the peripheral wall 34. A lower end part of the receiving portion 39 is formed with an accommodation groove 312. The accommodation groove 312 is formed by a pair of wall surfaces extending in the vertical direction and a flat surface extending in the lateral direction between the pair of wall surfaces in an XY plan view. One wire 90 is accommodated into the accommodation groove 312 from above. The accommodation groove 312 includes an opening 310 open in the upward direction Y1. In the receiving portion 39, a pair of tapered portions 313 are formed at positions continuous from the opening 310 in the upward direction Y1. The pair of tapered portions 313 are shaped to increase an interval in the lateral direction in the upward direction Y1. Thus, the receiving portion 39 includes the opening 310 open in the upward direction Y1, the accommodation groove 312 for accommodating the wire 90 at a proper position as described later and the pair of tapered portions 313 formed to be wider apart in the upward direction Y1 from the opening 310. As shown in FIGS. 1 and 5C, the peripheral wall 34 of the housing body 31 has a facing surface 34A facing the facing surface 59 of the cover member 50 at the time of assembly. The opening 310, the accommodation groove 312 and the tapered portions 313 constitute a part of the facing surface 34A. The tapered portion 313 may be curved, rather than being straight.

FIG. 5A is a front view in an XY plane showing a state before the cover member 50 is assembled and where the wires 90 are not inserted. The wire 90 is at the proper position if the wire 90 is accommodated in the accommodation groove 312 of the receiving portion 39 without entirely or partially protruding.

FIG. 5B is a front view in the XY plane showing a state before the cover member 50 is assembled and where the two wires 90 are accommodated in the respective accommodation grooves 312. The two wires 90 are accommodated into the respective accommodation grooves 312 by way of the pairs of tapered portions 313 and the openings 310. Due to the presence of the tapered portions 313, the wires 90 are easily guided to be accommodated into the accommodation grooves 312 located further in the downward direction Y2. In other words, the tapered portions 313 have a wire guiding function. By accommodating each wire 90 in each accommodation groove 312, each wire 90 is held at the proper position and workability such as assembly easiness of the cover member 50 is improved.

FIG. 5C is a front view in the XY plane showing a state where the cover member 50 is assembled and the wires 90 are held at the proper positions. In the wire pull-out portion 30A, when the pressing portions 57 and the receiving portions 39 are facing each other with the wires 90 held at the proper positions, the end surfaces of the pressing portions 57 and those of the receiving portions 39 are entirely facing each other with the pressing portions 57 and the receiving portions 39 held in close contact without any gaps. The accommodation grooves 312 of the receiving portions 39 of the wire pull-out portion 30A are arranged near a center of the front surface of the connector 10. By assembling the cover member 50 after the wires 90 are accommodated at the proper positions by being fit into the accommodation grooves 312, the jamming of the wires 90 is suppressed or reduced. By preventing the jamming, the damage of the wires 90 can be prevented. Note that, as shown in FIGS. 5B and 5C, the wires 90 are shown to be deformed in accordance with the shape of the accommodation grooves 312 in the exteriors of the respective wires 90 when the respective wires 90 are accommodated or fit into the accommodation grooves 312. However, the wires 90 may be accommodated or fit into the accommodation grooves 312 without the exteriors of the wires 90 being deformed.

For example, even if the wire 90 is located at halfway positions of the tapered portions 313 when the cover member 50 is assembled with the housing body 31, the pressing portion 57 can push the wire 90 to the proper position and the jamming of the wire 90 can be suppressed by the pressing portion 57 of the cover member 50 and the receiving portion 39 of the housing body 31.

Further, for example, since the tapered portions 313 having the guiding function when the cover member 50 is opened are present, the wires 90 are reliably guided and accommodated to the proper positions. Then, when the cover member 50 is assembled again, the jamming of the wires 90 by the pressing portions 57 and the receiving portions 39 can be suppressed.

Thus, with the wires 90 accommodated between the pressing portions 57 and the receiving portions 39, the wires 90 pulled-out in the forward direction Z1 from the wire pull-out portion 30A are held in a state accommodated at the proper positions and movements of the wires in the Z-axis direction (front-rear direction) and the Y-axis direction (vertical direction) can be suppressed. Further, since the respective wires 90 are reliably accommodated at the proper positions, it can be suppressed that the wires 90 swing and vibration is transmitted to the terminals 20.

### Assembly Method of Connector 10

Next, an assembly method of the connector 10 is described.

As shown in FIGS. 2 and 3, the slider 60 is first mounted into the mounting portion 40 of the housing body 31. In particular, the slider 60 is slid to the first position along the downward direction Y2 with the guide protrusions 69 fit in the guide grooves 41 and the wall portions 65 in the internal space of the spring accommodating portion 63 arranged in the cut portions 43. At this time, the slider 60 is slid along the downward direction Y2 with the guide protrusions 69 guided by the guide grooves 41.

Subsequently, the terminals 20, the wires 90 connected to the terminals 20 and the ferrite core 80 mounted on the outer peripheries of the wires 90 are inserted into the terminal accommodating portion 37 and the ferrite accommodating portion 38 of the housing body 31 along the downward direction Y2.

Subsequently, the spring 70 is mounted into the housing body 31 and the slider 60. Specifically, the spring 70 is mounted into the housing body 31 to accommodate the end parts in the forward direction Z1 of the respective arms 71 of the spring 70 into the respective spring accommodating portions 45 of the housing body 31. At this time, the coupling portion 75 of the spring 70 may not be accommodated in the spring accommodating portion 63 of the slider 60. For example, the coupling portion 75 may ride on the guiding portion 67 having a function of guiding the tip surface of the wall portion 66 in the internal space of the spring accommodating portion 63 and the spring 70 into the internal space of the spring accommodating portion 63.

Subsequently, as shown in FIGS. 1 and 3, the cover member 50 (see FIG. 4) is attached to the housing body 31. The spring 70 is pressed in the downward direction Y2 by this cover member 50. In this way, the coupling portion 75 of the spring 70 and the end parts in the rearward direction Z2 of the respective arms 71 are guided into the internal space of the spring accommodating portion 63 along the guiding portion 67. As a result, the spring 70 can be suitably accommodated into the spring accommodating portion 63 of the slider 60.

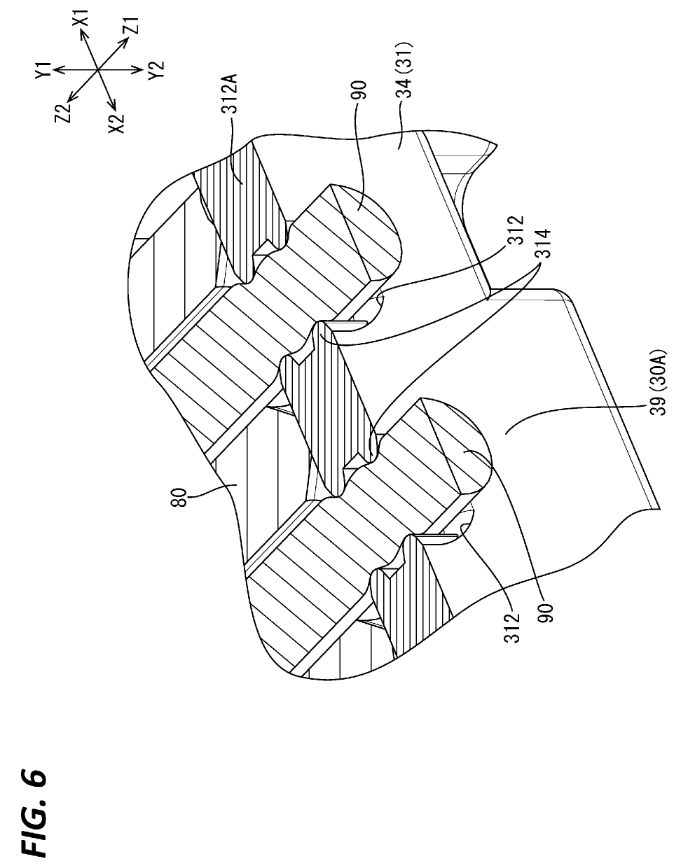

At this time, as shown in FIG. 5C, the wires 90 are accommodated at the proper positions in the accommodation grooves 312 of the receiving portions 39 of the wire pull-out portion 30A. As shown in FIG. 6, the accommodation groove 312 of the housing body 31 includes an inner wall 312A having a predetermined thickness in the Z-axis direction (front-rear direction) in the receiving portion 39. The inner wall 312A includes projections 314 projecting in the X-axis direction (lateral direction). The projections 314 are in the form of ribs extending in the vertical direction. The projections 314 sandwich a peripheral edge part of the wire 90 held at the proper position by being accommodated in the accommodation groove 312. In this embodiment, four projections 314 are provided for one wire 90 or one accommodation groove 312. If the wire 90 is held at the proper position of the accommodation groove 312, one or plural projections 314 may be, for example, provided.

According to this configuration, a movement of the wire 90 in the X-axis direction (lateral direction) can be suppressed by sandwiching the wire 90 in the X-axis direction (lateral direction) in the accommodation groove 312 by the projections 314. Further, since the wires 90 can be accommodated in the accommodation grooves 312 and held at the proper positions, for example, when an operation of removing the cover member 50 from the housing body 31 and assembling the cover member 50 again is necessary during an assembly operation, the jamming of the wires 90 can be more easily suppressed. Furthermore, since each wire 90 is reliably accommodated at the proper position, it can be suppressed that the wire 90 swings and vibration is transmitted to the terminal 20.

By the above process, the connector 10 can be assembled.

### Other Embodiments

The above embodiment can be modified and carried out as follows. The above embodiment and the following modifications can be combined with each other and carried out without technically contradicting.
(1) Although the connector 10 is provided with two wires 90 of the same type in the above embodiment, this is an example and a connector may be provided with a plurality of wires of one type or may be provided with a plurality of wires of two or more types as long as the object of the present disclosure is not impaired.
(2) Although the pair of receiving portions 39 are provided in the above embodiment, this is an example and at least one receiving portion may be provided as long as the object of the present disclosure is not impaired.
(3) Although the pair of pressing portions 57 are provided in the above embodiment, this is an example and at least one pressing portion may be provided as long as the object of the present disclosure is not impaired.
(4) Although the respective facing surfaces 34A, 59 of the pressing portions 57 and the receiving portions 39 are shaped to entirely face each other when the pressing portions 57 and the receiving portions 39 face each other with the wires 90 held at the proper positions in the wire pull-out portion 30A in the above embodiment, this is an example and the respective facing surfaces 34A, 59 of the pressing portions 57 and the receiving portions 39 may be shaped to partially face each other as long as the object of the present disclosure is not impaired.
(5) Although the accommodation grooves 312 of the receiving portions 39 of the wire pull-out portion 30A are arranged at lateral center positions of the peripheral wall 34 in the XY plan view of the connector in the above embodiment, this is an example and the arranged positions of the accommodation grooves 312 of the receiving portions 39 do not matter as long as the object of the present disclosure is not impaired.
(6) Although the projection 314 of the accommodation groove 312 shown in the above embodiment is in the shape of a rib extending in the vertical direction, this is an example and the projection 314 may have another shape as long as the object of the present disclosure is not impaired.
(7) The shape and thickness of the inner wall 312A of the accommodation groove 312 shown in the above embodiment is an example and an inner wall may have another thickness and another shape as long as the object of the present disclosure is not impaired.
(8) Although the inner wall 312A of the accommodation groove 312 shown in the above embodiment is provided with the projections 314, this is an example and the projections 314 may not be provided as long as the object of the present disclosure is not impaired.
(9) The assembly method of the connector 10 described in the above embodiment is an example and a connector may be manufactured by another assembly method as long as the object of the present disclosure is not impaired.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal;
a housing including a wire pull-out portion, the housing accommodating the terminal; and
a wire to be connected to the terminal, the wire being pulled out in a first direction from the wire pull-out portion of the housing;
the housing including a housing body and a cover member to be assembled with the housing body,
the wire pull-out portion including a receiving portion provided in the housing body, the receiving portion receiving the wire from one side in a second direction orthogonal to the first direction, and a pressing portion provided in the cover member, the pressing portion pressing the wire from another side in the second direction, and
the receiving portion including an accommodation groove having an opening open on the other side in the second direction, the wire being accommodated at a proper position in the accommodation groove, and a pair of tapered portions formed to be wider apart from the opening toward the other side in the second direction.

2. The connector of claim 1, wherein the wire is sandwiched in the second direction by the receiving portion and the pressing portion at the proper position.

3. The connector of claim 1, wherein an inner wall of the accommodation groove in the receiving portion is formed with a projection for sandwiching the wire in a third direction orthogonal to the first and second directions at the proper position.
